(19) United States
(12) Patent Application Publication
(10) Pub. No.: US 2014/0314971 A1
(43) Pub. Date: Oct. 23, 2014

(54) PRINTING SUBSTRATE WITH INTEGRATED FRAME

(71) Applicants: Christopher J. DOMANSKI, Mocksville, NC (US); Constance HENSHAW, Milford, CT (US); Candace L. OVERCASH, Statesville, NC (US); Gail M. NELLIS, Statesville, OH (US)

(72) Inventors: Christopher J. DOMANSKI, Mocksville, NC (US); Constance HENSHAW, Milford, CT (US); Candace L. OVERCASH, Statesville, NC (US); Gail M. NELLIS, Statesville, OH (US)

(73) Assignee: ELMER'S PRODUCTS, INC., Westerville, OH (US)

(21) Appl. No.: 14/258,639

(22) Filed: Apr. 22, 2014

Related U.S. Application Data
(60) Provisional application No. 61/814,478, filed on Apr. 22, 2013.

(51) Int. Cl. B41M 5/50; A47G 1/06

(52) U.S. Cl. CPC B41M 5/508; A47G 1/0633
USPC 428/32.18

(57) ABSTRACT

A printing substrate for use with digital imaging systems that includes a first layer that further includes a material suitable for receiving a printed image; a second layer attached to the first layer, wherein the second layer further includes a material that is different from and of greater rigidity than the material of the first layer, and wherein the second layer is operative to provide structural support to the first layer; and a frame made from and integral with the printing substrate, wherein the frame surrounds a centrally-placed square or rectangular region of the printing substrate, and wherein the frame further includes multiple foldable regions that are folded over, inward, and downward onto the second layer and secured thereto.

### CROSS-REFERENCE TO RELATED APPLICATIONS

This patent application claims the benefit of U.S. Provisional Patent Application Ser. No. 61/814,478 filed on Apr. 22, 2013 and entitled “Printing Substrate with Integrated Frame”, the disclosure of which is hereby incorporated by reference herein in its entirety and made part of the present U.S. utility patent application for all purposes.

### BACKGROUND OF THE INVENTION

The present invention relates generally to substrates for use with digital printers, and more specifically to a multi-layered, foam-paper substrate having an integrated frame that is compatible with large flatbed digital printers and digital printing techniques.

Digital imaging systems are commonplace in the modern business world and such systems are frequently used both for small scale printing jobs and for printing jobs that require larger formats such as signs and displays. Prior art substrates used with digital printers are often not appropriate for printing jobs that require larger formats due to a lack of rigidity, poor finishing quality, lack of uniformity in the printing surface, or other structural or compositional deficiencies. Thus, there is a need for a larger-scale printing substrate that is sturdy, reliable, and compatible with large flatbed digital printers.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a first printing substrate for use with digital imaging systems is provided. This printing substrate includes a first layer that further includes a material suitable for receiving a printed image thereon; a second layer attached to the first layer, wherein the second layer further includes a material that is different from and of greater rigidity than the material of the first layer, and wherein the second layer is operative to provide structural support to the first layer; and a frame made from and integral with the printing substrate. The integral frame surrounds a centrally-placed quadrilateral region of the printing substrate, and further includes four foldable regions that are folded over, inward, and downward onto the back of the second layer and secured thereto. Each of the four foldable regions further includes a first frame portion adjacent to the centrally-placed quadrilateral region and that further includes a first triangular tab formed from the first layer on the left outer edge of the first frame portion and a second triangular tab formed from the first layer on the right outer edge of the first frame portion; a first substantially V-shaped groove cut into the second layer between and parallel to the centrally-placed quadrilateral region and the first frame portion; a second frame portion adjacent and parallel to the first frame portion; a second substantially V-shaped groove cut into the second layer between and parallel to the first and second frame portions; a third frame portion adjacent and parallel to the second frame portion; a third substantially V-shaped groove cut into the second layer between and parallel to the second and third frame portions; a fourth frame portion adjacent and parallel to the third frame portion; and a fourth substantially V-shaped groove cut into the second layer between and parallel to the third and fourth frame portions.

In accordance with another aspect of the present invention, a second printing substrate for use with digital imaging systems is provided. This substrate includes a first layer that further includes a material suitable for receiving a printed image thereon, wherein the material suitable for receiving a printed image thereon further includes canvas or a canvas-like material; a second layer attached to the first layer, wherein the second layer further includes a material that is different from and of greater rigidity than the material of the first layer, and wherein the second layer is operative to provide structural support to the first layer; and a frame made from and integral with the printing substrate. The integral frame surrounds a centrally-placed quadrilateral region of the printing substrate and further includes four foldable regions that are folded over, inward, and downward onto the back of second layer and secured thereto. Each of the four foldable regions further includes a first frame portion adjacent to the centrally-placed quadrilateral region and that further includes a first triangular tab formed from the first layer on the left outer edge of the first frame portion and a second triangular tab formed from the first layer on the right outer edge of the first frame portion; a first substantially V-shaped groove cut into the second layer between and parallel to the centrally-placed quadrilateral region and the first frame portion; a second frame portion adjacent and parallel to the first frame portion; a second substantially V-shaped groove cut into the second layer between and parallel to the first and second frame portions; a third frame portion adjacent and parallel to the second frame portion; a third substantially V-shaped groove cut into the second layer between and parallel to the second and third frame portions; a fourth frame portion adjacent and parallel to the third frame portion; and) a fourth substantially V-shaped groove cut into the second layer between and parallel to the third and fourth frame portions.

In yet another aspect of this invention, a third printing substrate for use with digital imaging systems is also provided. This printing substrate includes a first layer that further includes a material suitable for receiving a printed image thereon, wherein the material suitable for receiving a printed image thereon further includes canvas or a canvas-like material; a second layer attached to the first layer, wherein the second layer further includes a material that is different from and of greater rigidity than the material of the first layer, wherein the second layer is operative to provide structural support to the first layer, and wherein the material of the second layer further includes foamboard; and a frame made from and integral with the printing substrate. The integral frame surrounds a centrally-placed quadrilateral region of the printing substrate, and further includes four foldable regions that are folded over, inward, and downward onto the second layer and secured thereto. Each of the four foldable regions further includes a first frame portion adjacent to the centrally-placed quadrilateral region and that further includes a first triangular tab formed from the first layer on the left outer edge of the first frame portion and a second triangular tab formed from the first layer on the right outer edge of the first frame portion; a first substantially V-shaped groove cut into the second layer between and parallel to the centrally-placed quadrilateral region and the first frame portion; a second frame portion adjacent and parallel to the first frame portion; a second substantially V-shaped groove cut into the second layer between and parallel to the first and second frame portions; a third frame portion adjacent and parallel to the second frame portion; a third substantially V-shaped groove cut into the second layer between and parallel to the second and third frame portions; a fourth frame portion adjacent and parallel to the third frame portion; and) a fourth substantially V-shaped groove cut into the second layer between and parallel to the third and fourth frame portions; and a third layer, wherein the third layer is attached to the second layer and wherein the V-shaped grooves are cut through the third layer and into the second layer.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### BRIEF DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is an exploded, perspective view of a first exemplary embodiment of the printing substrate of the present invention shown in a two-sided version;

FIG. 2 is an exploded, perspective view of a second exemplary embodiment of the printing substrate of the present invention shown in a two-sided version;

FIG. 3 is an exploded, perspective view of a third exemplary embodiment of the printing substrate of the present invention shown in a two-sided version;

FIG. 4 is a top view of an exemplary embodiment of this invention that has been adapted to include an integrated frame, wherein the printing substrate is pre-scored to provide a removable portion of the printable area that may be printed upon and then folded to create the integrated frame after the pre-scored section has been removed from the larger printing board;

FIG. 5 is a top view of the embodiment of FIG. 4 showing the foldable regions of the printing area after the pre-scored section has been removed from the larger printing board;

FIG. 6 is a bottom view of the embodiment of FIG. 4 showing the foldable regions of the printing area after the pre-scored section has been removed from the larger printing board;

FIG. 7 a bottom view of the embodiment of FIG. 4 showing the foldable regions of the printing surface area after it has been removed from the larger printing board and after two of the foldable regions have been folded over to create a partial integrated frame;

FIGS. 8A-B are side views of the embodiment of FIG. 4, showing the appearance of the V-shaped grooves cut into the substrate to allow the substrate to fold onto itself, as well as the appearance of the substrate after the cut areas have been folded over to create an integrated frame; and

FIG. 9 is a side view of an alternate embodiment of this invention, wherein the grooves cut into the substrate include a flattened portion or channel which facilitates folding of the integrated frame.

### DETAILED DESCRIPTION OF THE INVENTION

Exemplary embodiments of the present invention are now described with reference to the Figures. Although the following detailed description contains many specifics for the purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

As previously stated, the present invention provides a printing substrate for use with digital imaging systems such as large-scale digital flatbed printers. This substrate includes a first layer, wherein the first layer further includes a material suitable for receiving a printed image; a second layer, wherein the second layer is attached to the first layer, wherein the second layer further includes a material that is different than the material of the first layer, and wherein the second layer is operative to provide structural support to the first layer. The first layer may include glossy paper, fine art paper, fine art photo paper, canvas or canvas-like (i.e., durable and textured) material, or unbleached, uncoated, high-strength paperboard. The second layer may include a substantially rigid polystyrene core or other rigid or semi-rigid material. A third layer may be attached to the second layer and may include some or all of the components of the first layer. This printing substrate may be adapted to further include an integrated frame for providing structural support to the substrate. With reference now to the Figures, one or more specific embodiments of this invention shall be described in greater detail.

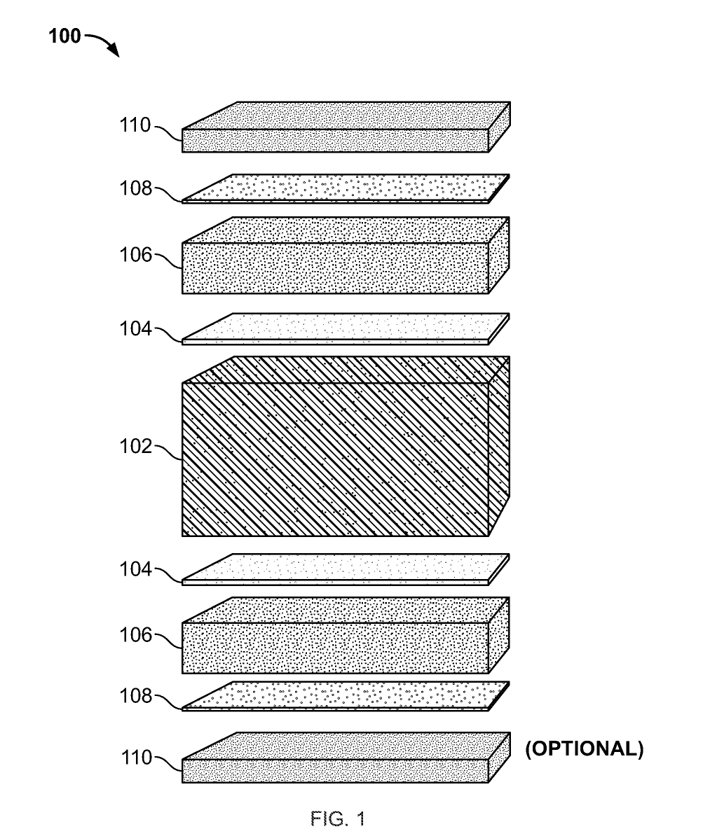

With general reference FIG. 1, the assembly and composition of a first exemplary embodiment of the printing substrate of present invention is shown. A first variant of this embodiment provides a single-sided version of the product referred to as “MightyPrint-Glossy” (Elmer's Products, Inc., Columbus, Ohio). This printing substrate includes a top layer, a middle layer, and a bottom layer. The top layer further includes first component 104, which is ethylene vinyl acetate (EVA) having a thickness of about 1.25 mil; second component 106, which is 16-pt clay coated solid bleached sulphate (SBS) paper; third component 108, which is low density polyethylene (LDPE) and binder having a thickness of about 0.7 mil; and fourth component 110, which is glossy paper, such as KROMEKOTE, having a weight of about 60 pounds. Middle layer 102 is attached to the top layer further includes a white rigid polystyrene core of about 0.25 inches in thickness. The bottom layer is attached to the middle layer and further includes first component 104, which is ethylene vinyl acetate (EVA) having a thickness of about 1.25 mil; second component 106, which is 16-pt clay coated solid bleached sulphate (SBS) paper; and third component 108, which is low density polyethylene (LDPE) and binder having a thickness of about 0.7 mil. A second variant of this embodiment provides a double-sided version of the product referred to as “MightyPrint-Glossy” (Elmer's Products, Inc., Columbus, Ohio). This printing substrate also includes a top layer, a middle layer, and a bottom layer. The top layer further includes first component 104, which is ethylene vinyl acetate (EVA) having a thickness of about 1.25 mil; second component 106, which is 16-pt clay coated solid bleached sulphate (SBS) paper; third component 108, which is low density polyethylene (LDPE) and binder having a thickness of about 0.7 mil; and fourth component 110, which is glossy paper, such as KROMEKOTE, having a weight of about 60 pounds. Middle layer 102 is attached to the top layer further includes a white rigid polystyrene core of about 0.25 inches in thickness. The bottom layer is attached to the middle layer and further includes first component 104, which is ethylene vinyl acetate (EVA) having a thickness of about 1.25 mil; second component 106, which is 16-pt clay coated solid bleached sulphate (SBS) paper; third component 108, which is low density polyethylene (LDPE) and binder having a thickness of about 0.7 mil; and fourth component 110, which is glossy paper, such as KROMEKOTE, having a weight of about 60 pounds. FIG. 1 shows the unassembled components of the double-sided variant of this embodiment. The glossy surface or surfaces of this embodiment make the traditional time-consuming process of achieving a high gloss surface by either applying a liquid laminate or printing on a high gloss paper and mounting to a board unnecessary. In alternate versions of the first exemplary embodiment of this invention, component 110 is replaced with either fine art paper (e.g., Museo or Canon) or fine art photo paper (Canon) or any of a variety of other papers that are adapted to receive printed images, particularly images created by digital printers.

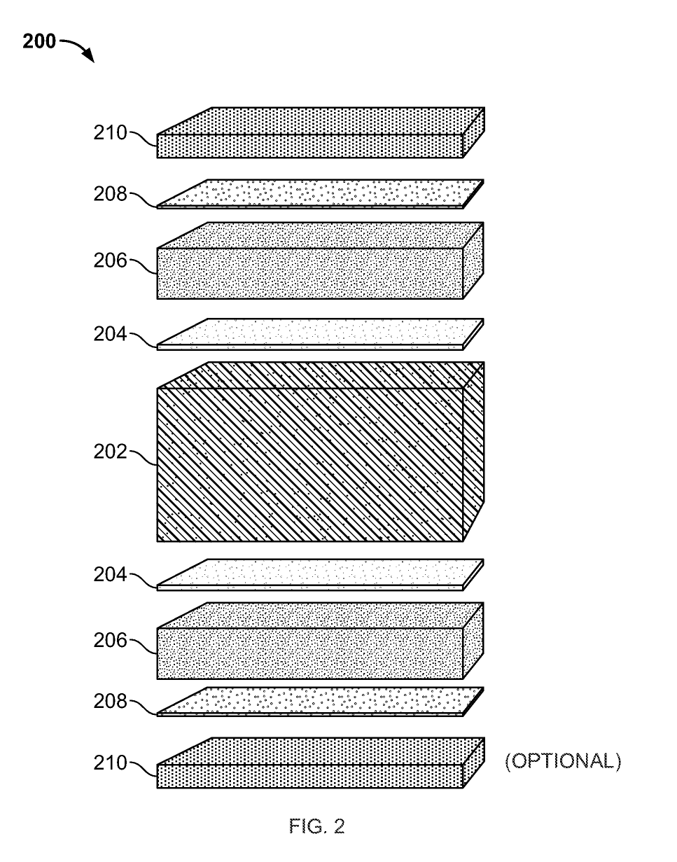

With general reference to FIG. 2, the assembly and composition of a second exemplary embodiment of the printing substrate of present invention is shown. A first variant of this embodiment provides a single-sided version of the product referred to as “MightyPrint-Canvas” (Elmer's Products, Inc., Columbus, Ohio). This printing substrate includes a top layer, a middle layer, and a bottom layer. The top layer further includes first component 204, which is ethylene vinyl acetate (EVA) having a thickness of about 1.25 mil; component 206, which is 16-18 pt base paper; component 208, which is low density polyethylene (LDPE) and binder having a thickness of about 0.75 mil; and component 210, which is Fredrix/Tara Artisan canvas. Middle layer 202 is attached to the top layer further includes a white rigid polystyrene core of about 0.25 inches in thickness. The bottom layer is attached to the middle layer and further includes first component 204, which is ethylene vinyl acetate (EVA) having a thickness of about 1.25 mil; component 206, which is 16-18 pt base paper; component 208, which is low density polyethylene (LDPE) and binder having a thickness of about 0.75 mil. A second variant of this embodiment provides a double-sided version of the product referred to as “MightyPrint-Canvas” (Elmer's Products, Inc., Columbus, Ohio). This printing substrate includes a top layer, a middle layer, and a bottom layer. The top layer further includes first component 204, which is ethylene vinyl acetate (EVA) having a thickness of about 1.25 mil; component 206, which is 16-18 pt base paper; component 208, which is low density polyethylene (LDPE) and binder having a thickness of about 0.75 mil; and component 210, which is Fredrix/Tara Artisan canvas. Middle layer 202 is attached to the top layer further includes a white rigid polystyrene core of about 0.25 inches in thickness. The bottom layer is attached to the middle layer and further includes first component 204, which is ethylene vinyl acetate (EVA) having a thickness of about 1.25 mil; component 206, which is 16-18 pt base paper; component 208, which is low density polyethylene (LDPE) and binder having a thickness of about 0.75 mil; and component 210, which is Fredrix/Tara Artisan canvas. FIG. 2 shows the unassembled components of the double-sided variant of this embodiment. The textured surface or surfaces of this embodiment enrich and enhance the artistic qualities of printed portraits, photo-graphics and painted images. In alternate versions of the second exemplary embodiment of this invention, the Fredrix/Tara Artisan canvas is replaced with any number of different canvas or canvas-like products that are capable of receiving a printed image. Examples of such materials include products that are commercially available from a variety of sources including, but not limited to Digital Rag, Electric Quilts Printables, Art Canvas, Cotton Painter's Canvas, Belgian Linen Canvas, and Jacquard Fabrics.

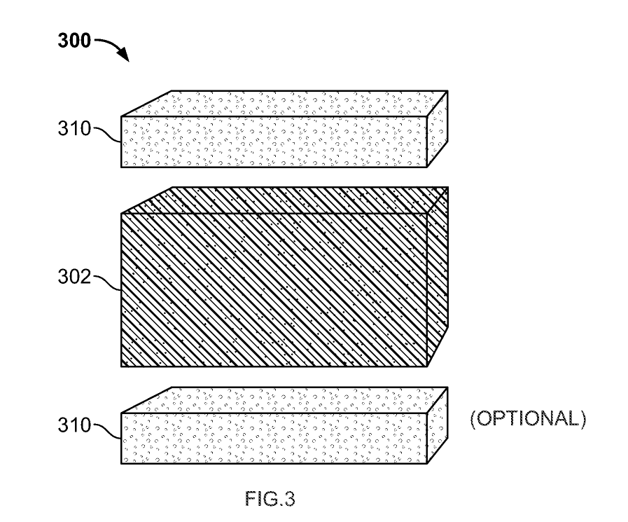

With general reference to FIG. 3, the assembly and composition of a third exemplary embodiment of the substrate of present invention is shown. A first variant of this embodiment provides a single-sided version of the product referred to as “MightyPrint-Premier Kraft” (Elmer's Products, Inc., Columbus, Ohio). This substrate also includes a top layer and a bottom layer. The top layer further includes component 310, which is unbleached, uncoated, high-strength paperboard having a weight of about 130 pounds, such as KRAFTPAK 130#. Bottom layer 302 is attached to the top layer further includes a white rigid polystyrene core of about 0.25 inches in thickness. A second variant of this embodiment provides a double-sided version of the product referred to as “MightyPrint-Premier Kraft” (Elmer's Products, Inc., Columbus, Ohio). This substrate also includes a top layer, a middle layer, and a bottom layer. The top layer further includes component 310, which is unbleached, uncoated, high-strength paperboard having a weight of about 130 pounds, such as KRAFTPAK 130#. Middle layer is 302 is attached to the top layer further includes a white rigid polystyrene core of about 0.25 inches in thickness. The bottom layer is attached to the middle layer and further includes component 310, which is unbleached, uncoated, high-strength paperboard having a weight of about 130 pounds, such as KRAFTPAK 130#. The warm undertone of this embodiment creates unique color nuances for the images being printed.

In general terms, the process for manufacturing an exemplary embodiment of the present invention includes the following components and steps. The foam component includes high heat polystyrene (HHPS) which is extruded on a large ( 6/8″) foam extruder through an annular (tubular) shaped die. The controls involved include a foam gauge mechanically controlled by a choke ring (for resisting polymer flow) and an adjustable die lip gap. Both controls can be performed on line; thus making it unnecessary to break the foam web to make any desired changes. The foam is extruded as large tube is then split into two symmetrical webs which are then thermally fused together with hot air. This heated/hot air is typically generated by natural gas burners. A fusion spline may help promote rigidity. Fusion of the symmetrical webs counteracts any circular-shaped memory in each sheet and provides a flatter, more rigid composite. Air is blown in between the two webs, and then composite web is immediately run through a series of rollers to complete bonding process. As further described below, an exemplary embodiment of the non-foam component is a composite of two papers and two adhesive layers.

Currently available products are typically saturated with undesirable chemicals such as melamine and urea formaldehyde. The exemplary embodiments of the present invention described herein include none of these chemicals. The saturation of such products also makes the paper very brittle and difficult to work with and the sharp edges and corners found thereon may require gloves for handling. MightyPrint's double adhesive layers provide an easier-to-cut board that does not suffer from these limitations. The present invention is compatible with at least the following printers: Gerber, EFI/VuTek, HP, Oce, and Gandinnovation, This invention is manufactured in a variety of finishes including glossy, matte, canvas, and photo.

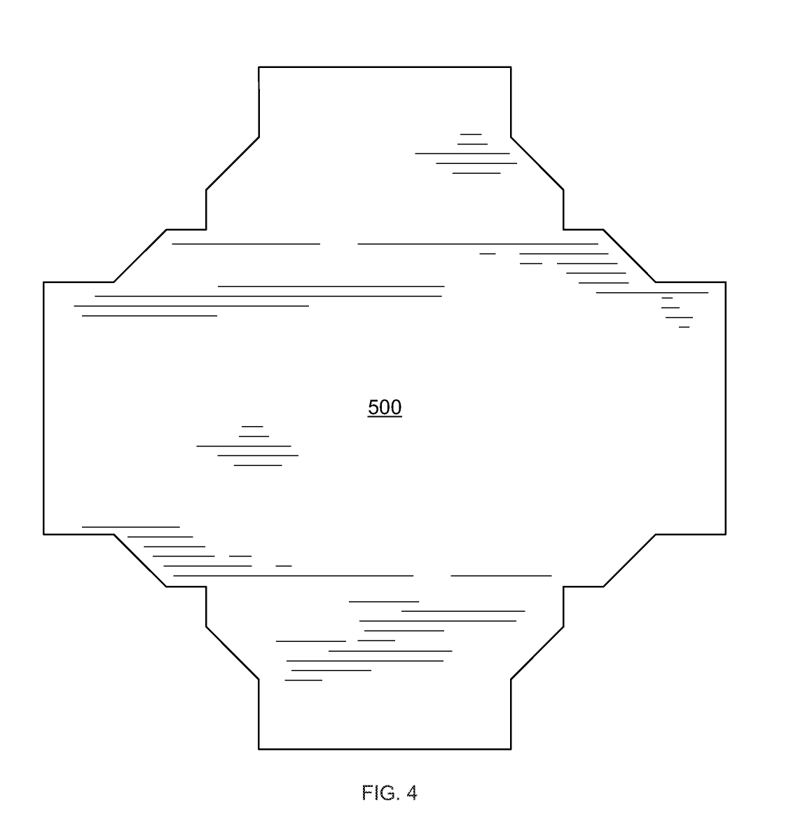

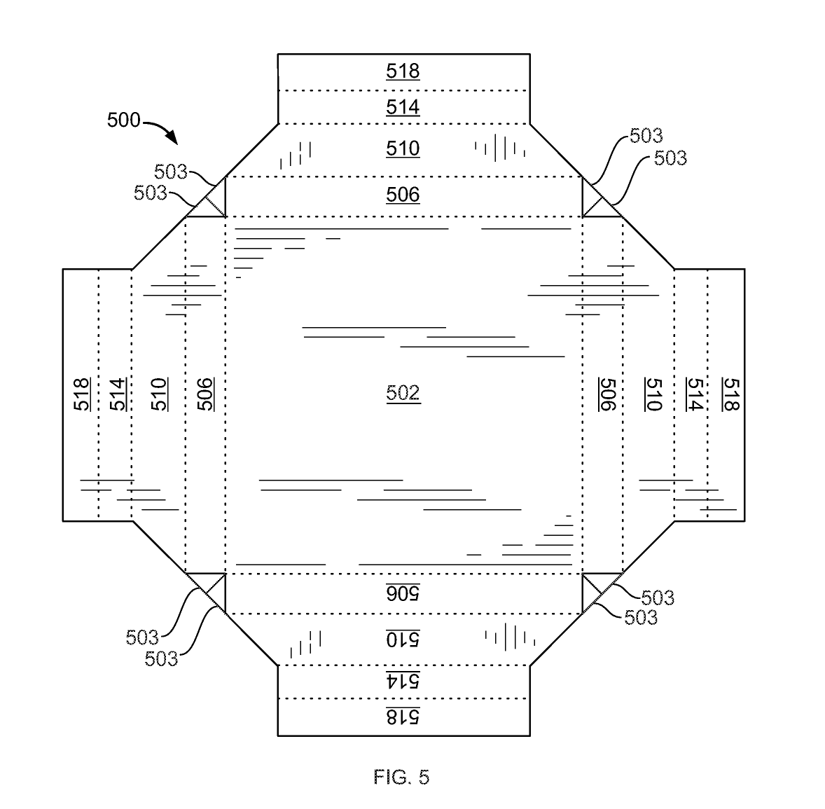

With reference to FIGS. 4-9, an exemplary embodiment of this invention that has been adapted to include an integrated frame is shown. This embodiment may involve only the single-sided versions of the present invention and is typically further limited to only the canvas-covered versions of the described product, although certain non-canvas versions are also compatible with this embodiment. In some variants of this embodiment (see FIG. 4), printing substrate 500 is provided in a large square or rectangular format the has been pre-scored using a predetermined combination of V-grooves, bevel cuts, and through-cuts to permit the final configuration of the printing substrate to be punched out of the larger piece of material after an image has been printed thereon. As shown in FIG. 5, which provides a top view of printing substrate 500, square or rectangular interior region 502 is surrounded by four flap-like outer regions that are divided into first frame portion 506, second frame portion 510, third frame portion 514, and fourth frame portion 518. As also shown in FIG. 5, in some embodiments, triangular flaps 503 are provided on the left and right hands sides of first frame portion 506 for creating a more finished edge on the integrated frame once the frame has been assembled.

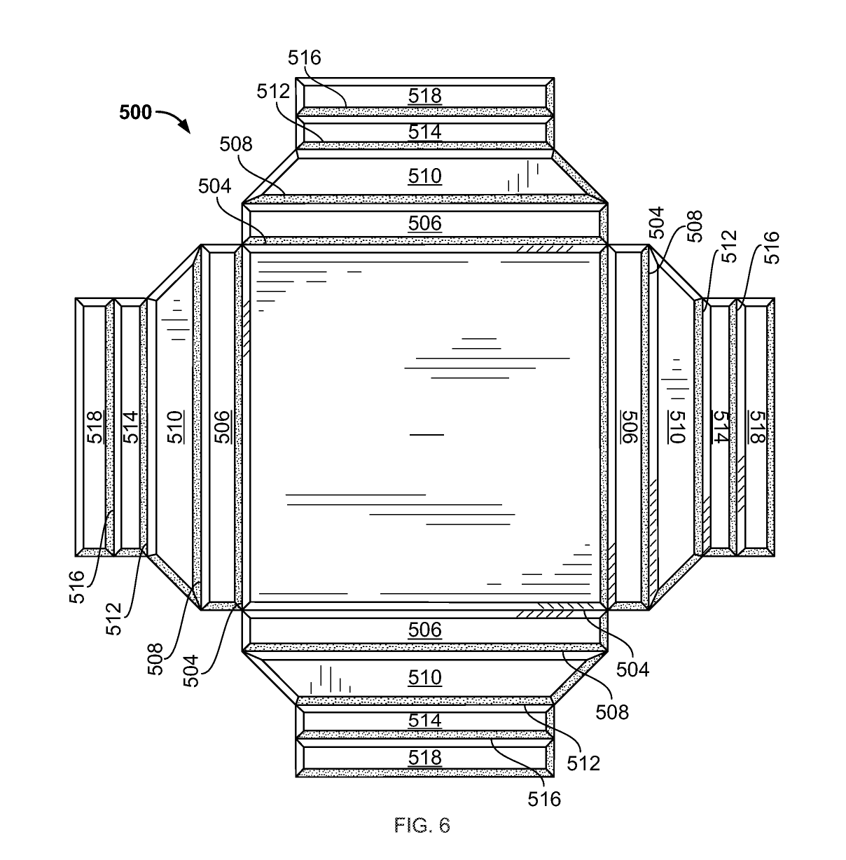

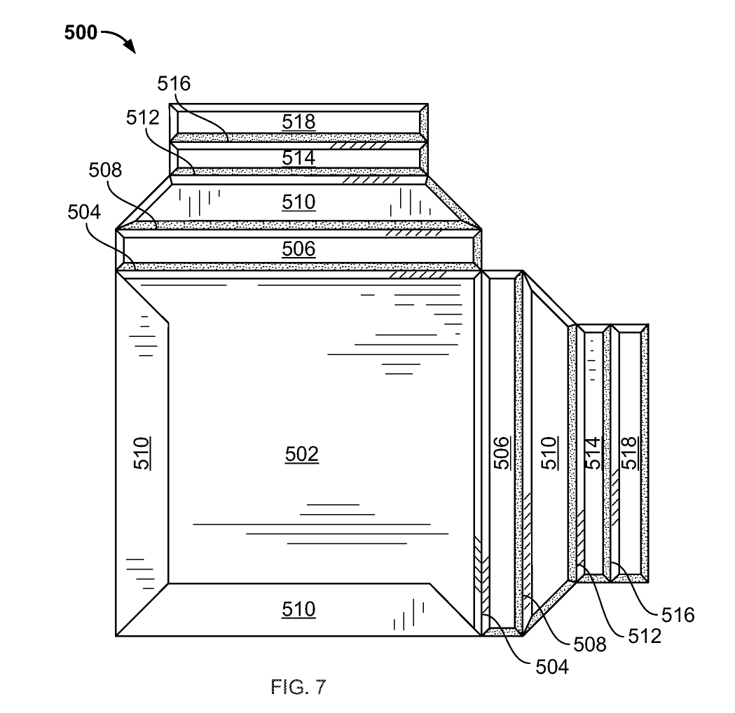

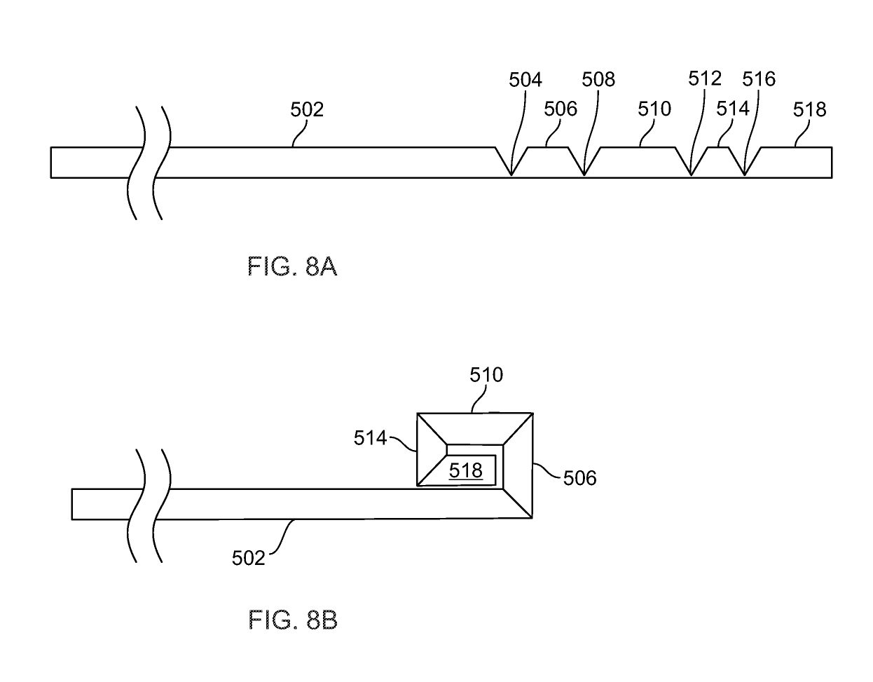

As shown in FIG. 6, which provides a bottom view of printing substrate 500, four roughly 90° V-shaped grooves 504, 508, 512, and 516 respectively are cut into the foamboard component of the four flap-like outer regions, but not into the canvas component or other surface component of the printing substrate. These grooves may be formed manually by or using a Zund Computerized Numeric Control (CNC) cutter or other similar device for allowing the flap-like outer regions be folded over and inward onto the bottom side of printing substrate 500, where they are then secured in place with glue, tape (3M), adhesive, or other known and sufficiently strong attachment means. In FIG. 7, the right and bottom flap-like outer regions remain unfolded while the left and top outer flap-like regions have been folded over and inward such that the upper surface of section 510 now faces outward from the bottom of printing substrate 500. FIG. 8A illustrates the geometry and placement of V-shaped grooves 504, 508, 512, and 516 when the flap-like regions are extended. FIG. 8B illustrates the appearance of the flap-like regions when they have been folded over and inward to create an integrated and supportive frame that surrounds interior region 502.

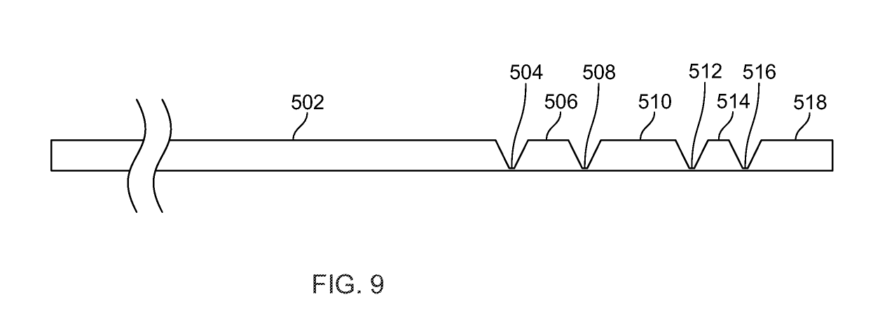

Once assembled, the integrated frame provides significant structural support and stability to the entire printing substrate without the need to mount the printing substrate on a separate wooden frame or support of any kind prior to hanging, framing or any final finishing or treatment of an image that has been printed on the upper surface of printing substrate 500. When an image has been printed on the front surface of area 502, a darker border may be included for creating a more finished appearance when the integrated frame is created. As shown in FIG. 9, in a further variant of this embodiment, the V-shaped grooves have been adapted to include a flattened bottom region that approaches or abuts the canvas or canvas-like component of the printing substrate. This flattened region results in more of a U-shaped groove or channel and facilitates folding of the integrated frame regions. This groove geometry also permits the canvas component to “breathe”, thereby reducing the likelihood that this component will crack or tear while the integrated frame is being assembled. Other groove or channel geometries are possible.

Alternate embodiments of the present invention, include: (i) white: clay-coated paper facers with a resilient polystyrene “memory” core; available in four thicknesses; (ii) Black-on-Black®: rich, black, acid-free paper facers with a black polystyrene core; (iii) colors: colored paper facers with a resilient polystyrene core; (iv) Natural Kraft: available with “memory” or “crushable” core; (v) White-Black-Black White: clay-coated facer on one side, ½ thick black foam core, black-on-black acid-free paper facer; and (vi) PilloCore®: clay-coated paper facers with a “crushable” polystyrene core. Alternate embodiments of available rigid boards include: (i) MightyCore®: ultra-smooth paper facers with a dense polystyrene core; (ii) MightyPrint Expressions®: unique textured surfaces with a dense polystyrene core with canvas, glossy and premier kraft; and (iii) MightyBull®: high-impact polystyrene (plastic) facers with a dense polystyrene core. Other alternate finishes include: (i) Extreme White: smooth, bright white paper facers with a polystyrene core; (ii) Bright White MightyCore®: smooth, bright white paper facers with a dense polystyrene core; and (iii) Embossed Canvas: a canvas surface that gives printed images a rich, hand-painted appearance.

Various configurations and finishes include: (i) art on canvas board; (ii) creation of canvas wraps with printed canvas boards (referred to as “Gallery Canvas Wrap”); (iii) personalized or decorator cork boards; and (iv) art on wood grain board. Table 1, below includes additional information for these embodiments.

TABLE 1
Sources and Specifications for Various Finishes

| SURFACE | SOURCE | SPECIFICATIONS |
|---|---|---|
| Embossed Canvas | Neenah Eames | Regular 3/16″ foam |
| on Regular 3/16″ | Canvas | with paper embossed |
| | | canvas on two sides |
| Embossed Canvas | Neenah Eames | MightyCore 3/16″ foam |
| on Rigid 3/16″ | Canvas | with paper embossed |
| | | canvas on one side |
| Real Canvas | Fredrix/Tara | MightyCore ¼″ foam |
| on Rigid ¼″ | | with paper embossed |
| | | canvas on one side |
| Cork | PORTUGALIACORK | Regular ⅜″ foam |
| | S.A | with cork on one side |
| Light | CPS Resources | Regular 3/16″ foam |
| Woodgrain | Hampden Paper 1 | with light woodgrain |
| (Birch) | Hampden Paper 2 | paper on one side |
| | Hampden Paper 3 | |

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1. A printing substrate for use with digital imaging systems, comprising:
(a) a first layer, wherein the first layer further includes a material suitable for receiving a printed image thereon;
(b) a second layer, wherein the second layer is attached to the first layer, wherein the second layer further includes a material that is different from and of greater rigidity than the material of the first layer, and wherein the second layer is operative to provide structural support to the first layer; and
(c) a frame made from and integral with the printing substrate, wherein the frame surrounds a centrally-placed quadrilateral region of the printing substrate, wherein the frame further includes four foldable regions that are folded over, inward, and downward onto the second layer and secured thereto, and wherein each of the four foldable regions further includes:
(i) a first frame portion adjacent to the centrally-placed quadrilateral region, wherein the first frame portion further includes a first triangular tab formed from the first layer on the left outer edge of the first frame portion and a second triangular tab formed from the first layer on the right outer edge of the first frame portion;
(ii) a first substantially V-shaped groove cut into the second layer between and parallel to the centrally-placed quadrilateral region and the first frame portion;
(iii) a second frame portion adjacent and parallel to the first frame portion;
(iv) a second substantially V-shaped groove cut into the second layer between and parallel to the first and second frame portions;
(v) a third frame portion adjacent and parallel to the second frame portion;
(vi) a third substantially V-shaped groove cut into the second layer between and parallel to the second and third frame portions;
(vii) a fourth frame portion adjacent and parallel to the third frame portion; and
(viii) a fourth substantially V-shaped groove cut into the second layer between and parallel to the third and fourth frame portions.

2. The printing substrate of claim 1, further comprising, optionally, a third layer, wherein the third layer is attached to the second layer and wherein the V-shaped grooves are cut through the third layer and into the second layer.

3. The printing substrate of claim 1, wherein the material suitable for receiving a printed image further includes canvas, a canvas-like material, cork-like surfacing, woodgrain-like surfacing, or combinations thereof.

4. The printing substrate of claim 1, wherein the first layer is a multi-component layer, and wherein the multiple components of the first layer further include the material suitable for receiving a printed image; low density polyethylene and binder having a thickness of about 0.70 mil; 16-18 pt base paper; and ethylene vinyl acetate having a thickness of about 1.25 mil.

5. The printing substrate of claim 1, wherein the second layer further includes a substantially rigid polystyrene core.

6. The printing substrate of claim 5, wherein the thickness of the substantially rigid polystyrene core is about 0.25 inches.

7. The printing substrate of claim 1, wherein the grooves are cut into the second layer using a computer numeric control cutter or are manually cut into the second layer.

8. The printing substrate of claim 1, wherein the image printed on the first layer is printed using a flatbed digital printer.

9. A printing substrate for use with digital imaging systems, comprising:
(a) a first layer, wherein the first layer further includes a material suitable for receiving a printed image thereon, and wherein the material suitable for receiving a printed image thereon further includes canvas or a canvas-like material;
(b) a second layer, wherein the second layer is attached to the first layer, wherein the second layer further includes a material that is different from and of greater rigidity than the material of the first layer, and wherein the second layer is operative to provide structural support to the first layer; and
(c) a frame made from and integral with the printing substrate, wherein the frame surrounds a centrally-placed quadrilateral region of the printing substrate, wherein the frame further includes four foldable regions that are folded over, inward, and downward onto the second layer and secured thereto, and wherein each of the four foldable regions further includes:
(i) a first frame portion adjacent to the centrally-placed quadrilateral region, wherein the first frame portion further includes a first triangular tab formed from the first layer on the left outer edge of the first frame portion and a second triangular tab formed from the first layer on the right outer edge of the first frame portion;
(ii) a first substantially V-shaped groove cut into the second layer between and parallel to the centrally-placed quadrilateral region and the first frame portion;
(iii) a second frame portion adjacent and parallel to the first frame portion;
(iv) a second substantially V-shaped groove cut into the second layer between and parallel to the first and second frame portions;
(v) a third frame portion adjacent and parallel to the second frame portion;
(vi) a third substantially V-shaped groove cut into the second layer between and parallel to the second and third frame portions;
(vii) a fourth frame portion adjacent and parallel to the third frame portion; and
(viii) a fourth substantially V-shaped groove cut into the second layer between and parallel to the third and fourth frame portions.

10. The printing substrate of claim 9, further comprising, optionally, a third layer, wherein the third layer is attached to the second layer and wherein the V-shaped grooves are cut through the third layer and into the second layer.

11. The printing substrate of claim 9, wherein the first layer is a multi-component layer, and wherein the multiple components of the first layer further include canvas or a canvas-like material; low density polyethylene and binder having a thickness of about 0.70 mil; 16-18 pt base paper; and ethylene vinyl acetate having a thickness of about 1.25 mil.

12. The printing substrate of claim 9, wherein the second layer further includes a substantially rigid polystyrene core.

13. The printing substrate of claim 12, wherein the thickness of the substantially rigid polystyrene core is about 0.25 inches.

14. The printing substrate of claim 9, wherein the grooves are cut into the second layer using a computer numeric control cutter or are manually cut into the second layer.

15. The printing substrate of claim 9, wherein the image printed on the first layer is printed using a flatbed digital printer.

16. A printing substrate for use with digital imaging systems, comprising:
(a) a first layer, wherein the first layer further includes a material suitable for receiving a printed image thereon, and wherein the material suitable for receiving a printed image thereon further includes canvas or a canvas-like material;
(b) a second layer, wherein the second layer is attached to the first layer, wherein the second layer further includes a material that is different from and of greater rigidity than the material of the first layer, wherein the second layer is operative to provide structural support to the first layer, and wherein the material of the second layer further includes foamboard;
(c) a frame made from and integral with the printing substrate, wherein the frame surrounds a centrally-placed quadrilateral region of the printing substrate, wherein the frame further includes four foldable regions that are folded over, inward, and downward onto the second layer and secured thereto, and wherein each of the four foldable regions further includes:
(i) a first frame portion adjacent to the centrally-placed quadrilateral region, wherein the first frame portion further includes a first triangular tab formed from the first layer on the left outer edge of the first frame portion and a second triangular tab formed from the first layer on the right outer edge of the first frame portion;
(ii) a first substantially V-shaped groove cut into the second layer between and parallel to the centrally-placed quadrilateral region and the first frame portion;
(iii) a second frame portion adjacent and parallel to the first frame portion;
(iv) a second substantially V-shaped groove cut into the second layer between and parallel to the first and second frame portions;
(v) a third frame portion adjacent and parallel to the second frame portion;
(vi) a third substantially V-shaped groove cut into the second layer between and parallel to the second and third frame portions;
(vii) a fourth frame portion adjacent and parallel to the third frame portion; and
(viii) a fourth substantially V-shaped groove cut into the second layer between and parallel to the third and fourth frame portions; and
(d) a third layer, wherein the third layer is attached to the second layer and wherein the V-shaped grooves are cut through the third layer and into the second layer.

17. The printing substrate of claim 16, wherein the first layer is a multi-component layer, and wherein the multiple components of the first layer further include canvas or a canvas-like material; low density polyethylene and binder having a thickness of about 0.70 mil; 16-18 pt base paper; and ethylene vinyl acetate having a thickness of about 1.25 mil.

18. The printing substrate of claim 16, wherein the foamboard further includes a substantially rigid polystyrene core.

19. The printing substrate of claim 18, wherein the thickness of the substantially rigid polystyrene core is about 0.25 inches.

20. The printing substrate of claim 16, wherein the grooves are cut into the second layer using a computer numeric control cutter.
